(19) United States
(12) Patent Application Publication
(10) Pub. No.: US 2007/0126945 A1
(43) Pub. Date: Jun. 7, 2007

(54) LIQUID CRYSTAL PANEL, LIQUID CRYSTAL DISPLAY, MANUFACTURING METHOD OF LIQUID CRYSTAL PANEL, AND MANUFACTURING APPARATUS OF LIQUID CRYSTAL PANEL

(75) Inventor: Masayuki TASHIRO, Osaka-shi, Osaka (JP)

Correspondence Address: SHARP KABUSHIKI KAISHA;C/O KEATING & BENNETT, LLP, 8180 GREENSBORO DRIVE, SUITE 850, MCLEAN, VA, 22102, US

(73) Assignee: SHARP KABUSHIKI KAISHA, Osaka (JP)

(21) Appl. No.: 11/672,187

(22) Filed: Feb. 7, 2007

Related U.S. Application Data
(63) Continuation of application No. PCT/JP05/13073, filed on Jul. 14, 2005.

(30) Foreign Application Priority Data
Aug. 9, 2004 (JP) 2004-232504

(51) Int. Cl. G02F 1/1333

(52) U.S. Cl. 349/54; 349/110

(57) ABSTRACT

A liquid crystal panel includes a pair of glass substrates and, and a liquid crystal layer provided therebetween. In a surface at a side opposite from the liquid crystal layer in the glass substrate, a recessed part is formed at a position corresponding to a foreign substance (bright spot defect portion). A light shielding layer which shields light is formed in the recessed part. Accordingly, when comparing with the case where a light shielding layer is formed on the surface of a glass substrate as conventional display, a distance between the light shielding layer and the foreign substance can be made short, and thereby, the light shielding range by the light shielding layer can be made larger than a conventional display.

### CROSS REFERENCE TO RELATED APPLICATIONS

This application claims priority from Japanese Patent Application No. 2004-232504 filed Aug. 9, 2004. The entire content of this priority application is incorporated herein by reference.

### BACKGROUND OF THE INVENTION

1. Field of the Invention

The disclosure relates to a liquid crystal panel, a liquid crystal display, a manufacturing method of the liquid crystal panel and a manufacturing apparatus of the liquid crystal panel.

2. Description of the Related Art

An outline of the manufacturing method of the liquid crystal panel will be described hereinafter. Switching elements (for example, TFTs), pixel electrodes and the like are provided at one of a pair of glass substrates, and after counter electrodes and the like are provided at the other glass substrate, both the glass substrates are bonded to each other via a small gap therebetween. Then, a liquid crystal layer is formed by filling liquid crystal between both the glass substrates, and thereafter, polarizing plates are respectively stuck to the surfaces of both the glass substrates.

In the manufacturing process of the liquid crystal panel as described above, a defect is detected by conducting various kinds of inspections after respective process steps, and in the inspection conducted after the liquid crystal layer is formed, presence and absence of a display failure is inspected by disposing a pair of polarizing plates for inspection to sandwich both the glass substrates, and driving a switching element with a backlight for inspection lit.

In this case, when there is a switching element with an operation failure, it can be sometimes detected as a bright spot defect which looks bright even though black display is performed. The bright spot defect which always transmits light like this significantly degrades display quality and reduces manufacturing yield.

Thus, as the methods for correcting the bright spot defect as described above, the ones disclosed in Japanese Patent Laid-Open No. 7-333588 (Patent Document 1) and Japanese Patent Laid-Open No. 2002-341788 (Patent Document 2) are known. In these methods, a bright spot defect is converted into a black spot defect by forming a light shielding film which shields light in the position corresponding to the bright spot defect in the surface of a glass substrate. The black spot defect is a defect which is less recognizable visually as compared with a bright spot defect, and therefore, degradation of display quality can be suppressed by the above described correcting method.

Further, as another correcting method, the one disclosed in the following Japanese patent Laid-Open No. 9-258267 (Patent Document 3) is cited, and in this method, a bright spot defect is converted into a black spot defect by destroying the counter electrode corresponding to a switching element with a operation failure with a laser beam.

Incidentally, as the cause of a bright spot defect, for example, a foreign substance entering a liquid crystal layer sometimes becomes the cause of it other than the failure of a switching element as described above. In this case, light falls on a very small foreign substance included in the liquid crystal layer, and irregularly reflects, and thereby, the foreign substance is visually recognized as a bright spot even at the time of black display.

As the method for correcting a bright spot defect based on the failure of a switching element, there are the methods disclosed in Patent Documents 1 to 3 which are already described, but as the method for correcting the bright spot defect based on a foreign substance, there is none that is established. Thus, with respect to a bright spot defect based on a foreign substance, it is conceivable to cope with it by also using the methods for correcting a bright spot defect based on the failure of a switching element.

However, when the techniques disclosed in the above described Patent Documents 1 and 2 are applied to a bright spot defect based on a foreign substance, the following problem occurs. Namely, since the light falling on a foreign substance irregularly reflects, a bright spot is difficult to recognize when the portion provided with a light shielding layer is seen from the front, but there is the problem that when it is seen diagonally, the bright spot is easily recognized visually, and when further enhancement in display quality is demanded, there are difficulties in coping with it.

Further, when the technique disclosed in the above described Patent Document 3 is applied to a bright spot defect based on a foreign substance, the following problem occurs. Namely, since the position of a foreign substance has nothing to do with the position of the switching element, when the foreign substance is disposed across a plurality of switching elements, a plurality of dots have to be converted into black spot defects, and the black spot becomes large. Therefore, when further enhancement in display quality is demanded, it is difficult to cope with it.

### SUMMARY OF THE INVENTION

The present invention is completed based on the circumstances as described above, and has an object to enhance display quality.

In order to attain the above described object, the present invention includes a pair of glass substrates (plural) which are capable of transmitting light emitted from an external light source, and disposed at a side of a viewer and a side opposite from it to be opposed to each other, a liquid crystal layer interposed between both of said glass substrates (plural), liquid crystal orientation control elements (plural) which are capable of controlling an orientation state of said liquid crystal layer by applying voltage between both of said glass substrates (plural), polarizing layers (plural) which are stacked on surfaces at sides opposite from said liquid crystal layer in both of said glass substrates (plural), a recessed part (singular) which is formed at a position corresponding to a bright spot defect portion (singular) in the surface at the side opposite from said liquid crystal layer in the glass substrate (singular) at a side opposite from the glass substrate (singular) at the side of the viewer of both of said glass substrates (plural), and a light shielding layer (singular) formed in said recessed part.

A bright spot defect is caused by a foreign substance which enters, for example, a liquid crystal layer to cause light to irregularly reflect. When such a defect occurs, a recessed part is formed at the position corresponding to a bright spot defect portion in the surface at the side opposite from the liquid crystal layer of the glass substrate, and the light shielding layer is formed in the recessed part to shield light.

According to the present invention, the light shielding layer is formed in the recessed part, and therefore, as compared with the case where a light shielding layer is formed on the surface of the glass substrate as in a conventional display, the distance between the light shielding layer and a foreign substance can be made short. Accordingly, the light shielding range can be made larger than the conventional display, and thereby, display quality can be enhanced. A bright spot defect portion is sometimes caused by a flaw on the surface of the glass substrate, and in this case, the recessed part is formed in the position corresponding to the bright spot defect portion and the light shielding layer is formed in the recessed part, thereby shielding light.

Preferred embodiments in accordance with the invention will be described in detail with reference to the following figures.

### BRIEF DESCRIPTION OF THE DRAWINGS

FIG. 1 is a sectional view showing an outline of a liquid crystal panel according to preferred embodiment 1 of the present invention.

FIG. 2 is a plane view showing an outline of a glass substrate on a side provided with TFTs and the like.

FIG. 3 is a side view showing an outline of a recessed part forming device mounted with the liquid crystal panel.

FIG. 4 is a sectional view showing a state in which a recessed part is formed in the glass substrate.

FIG. 5 is a sectional view showing a state in which cashew lacquer is charged into the recessed part.

FIG. 6 is a sectional view showing a state in which decompression is performed by a decompressing device.

FIG. 7 is a sectional view showing a state in which excess cashew lacquer is removed.

FIG. 8 is a sectional view showing a state in which polarizing plates are bonded to the glass substrates and a backlight is assembled.

FIG. 9 is a sectional view for explaining a light shielding range by a light shielding layer.

FIG. 10 is a plane view showing a state in which a protection cover is put on a liquid crystal panel according to preferred embodiment 2 of the present invention.

FIG. 11 is a plane view showing a state in which the protection cover is put on a liquid crystal panel according to a modification example of the preferred embodiment 2.

### DETAILED DESCRIPTION OF THE PREFERRED EMBODIMENTS

### Preferred Embodiment 1

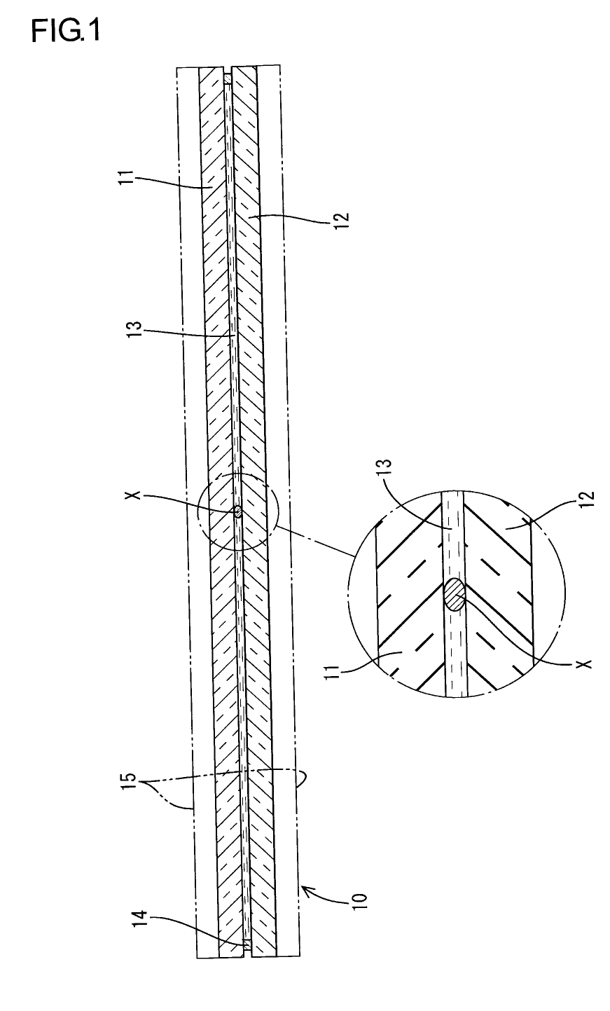

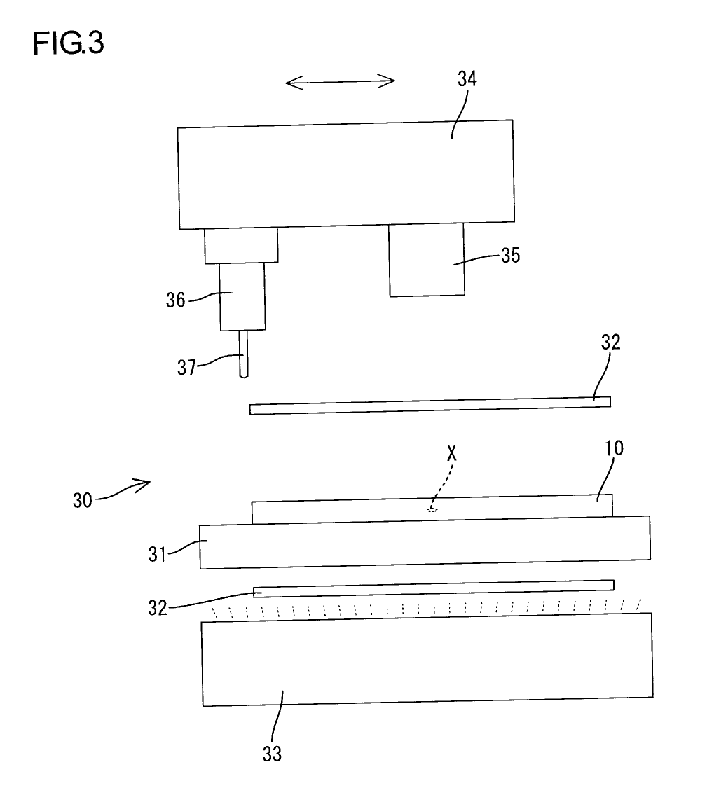

Preferred embodiment 1 of the present invention will be described based on FIGS. 1 to 9. In the preferred embodiment 1, a liquid crystal panel 10 of a normally black mode using a TFT 16 as a switching element is illustrated.

First, the outline of the structure of the liquid display panel 10 will be described. The liquid crystal panel 10 is constituted of a pair of glass substrates 11 and 12 which are disposed to be in an opposed state with a predetermined gap provided therebetween, a liquid crystal layer 13 which is sandwiched between both the glass substrates 11 and 12, a sealant 14 which is provided at perimeter portions of both the glass substrates 11 and 12 to seal liquid crystal layer 13, and a pair of polarizing plates 15 which are stacked on surfaces at the side opposite from the liquid crystal layer 13 in both the glass substrates 11 and 12 as roughly described in FIG. 1. The thickness dimension of the glass substrates 11 and 12 is about 700 μm, the thickness dimension of the liquid crystal layer 13 is about 3 to 5 μm, and the thickness dimension of the polarizing plate 15 is about 300 μm.

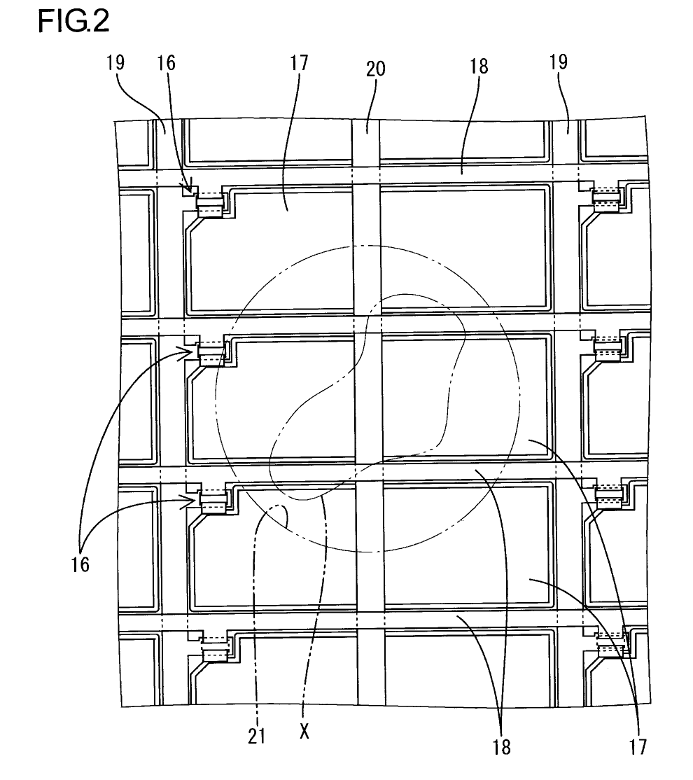

On the surface at the side of the liquid crystal 13 in the glass substrate 11 at the upper side (side opposite from the viewer side) shown in FIG. 1 out of both the glass substrates 11 and 12, as described in FIG. 2, a number of pixel electrodes 17 which are connected to drain electrodes of the TFTs 16 are arranged in parallel in a matrix shape with the TFTs 16, and source wiring 18 which is connected to a source electrode of the TFTs 16 and gate wiring 19 which is connected to a gate electrode of the TFTs 16 are provided to be orthogonal to each other while passing the perimeter of each of the pixel electrodes 17. Each of the pixel electrodes 17 forms a slim and long rectangular shape along the extending direction of the source wiring 18, and its long side is about 600 μm, while its short side is about 200 μm. The central portion at the side of the long side in each of the pixel electrodes 17 constitutes a retention capacity, and common wiring 20 parallel with the gate wiring 19 is provided in this portion via an insulating layer. Three pixel electrodes 17 adjacent in the direction of the short side of the pixel electrode 17 (the up and down direction shown in FIG. 2) correspond to the respective colors of R, G and B, and these three display dots constitute one pixel.

On the surface at the side of the liquid crystal layer 13 in the glass substrate 12 at the lower side (viewer side) shown in FIG. 1 out of both the glass substrates 11 and 12, a color filter layer and a counter electrode not shown are provided at the position opposed to each of the above described pixel electrodes 17. Of both the glass substrates 11 and 12, the glass substrate 11 provided with the TFTs 16, the pixels electrodes 17 and the like is on the side of the backlight B (side opposite from the viewer side), and the glass substrate 12 provided with the color filters, the counter electrodes and the like is on the side of the display which is visually recognized by a visual recognizer (the viewer side).

Subsequently, a method for manufacturing the liquid crystal panel 10 will be described. While the TFTs 16, the pixel electrodes 17 and the like are formed on the one glass substrate 11, the color filters, the opposed electrodes and the like are formed on the other glass substrate 12. Then, both the glass substrates 11 and 12 are bonded to each other so as to be opposed to each other with a predetermined gap secured via the sealant 14 provided at the perimeter portion of either the glass substrate 11 or 12. Thereafter, when the liquid crystal layer 13 is formed by filling liquid crystal between both the glass substrates 11 and 12, the polarizing plates 15 are bonded on the surfaces at the side opposite from the liquid crystal layer 13 side in both the glass substrates 11 and 12, respectively.

In the above described manufacturing process, a defect is detected by conducting each of various inspections each time each process step is finished, and with respect to the liquid crystal panel 10 in which a defect is detected, repair is applied for the one capable of being repaired. As one of the inspections, there is a lighting inspection which is performed when the process step of forming the liquid crystal layer 13 of the manufacturing process is finished, and in this lighting inspection, presence and absence of a display failure is inspected.

More specifically, a pair of polarizing plates for inspection are disposed so as to sandwich both the glass substrates 11 and 12, a backlight for inspection is lit, and each wiring formed on the glass substrate 11 is connected to a circuit for inspection to supply a signal properly to each wiring to drive the TFTs 16, the orientation state of the liquid crystal which constitutes the liquid crystal layer 13 is controlled, and thereby, a display state is obtained. The display state thus obtained is inspected by being subjected to image processing, visually checked by an inspector and the like. At this time, even though the display is caused to perform black display, a bright spot defect which is visually recognized to be bright in a spot shape by light being transmitted, irregularly reflected or the like is sometimes detected. The bright spot defect sometimes occurs because light falls on a foreign substance X entering the liquid crystal layer 13 and irregularly reflects, and the inventor of the present application converted the bright spot defect into a black sport defect by performing repair which will be described in detail subsequently. The foreign substance X is considered to be likely to adhere to the surfaces at the side of the liquid crystal layer 13 in the glass substrates 11 and 12 in the step before the liquid crystal is filled or considered to be mixed into the liquid crystal, and its fixation position has nothing to do with the disposition of the TFTs 16, the pixel electrode 17 and the like.

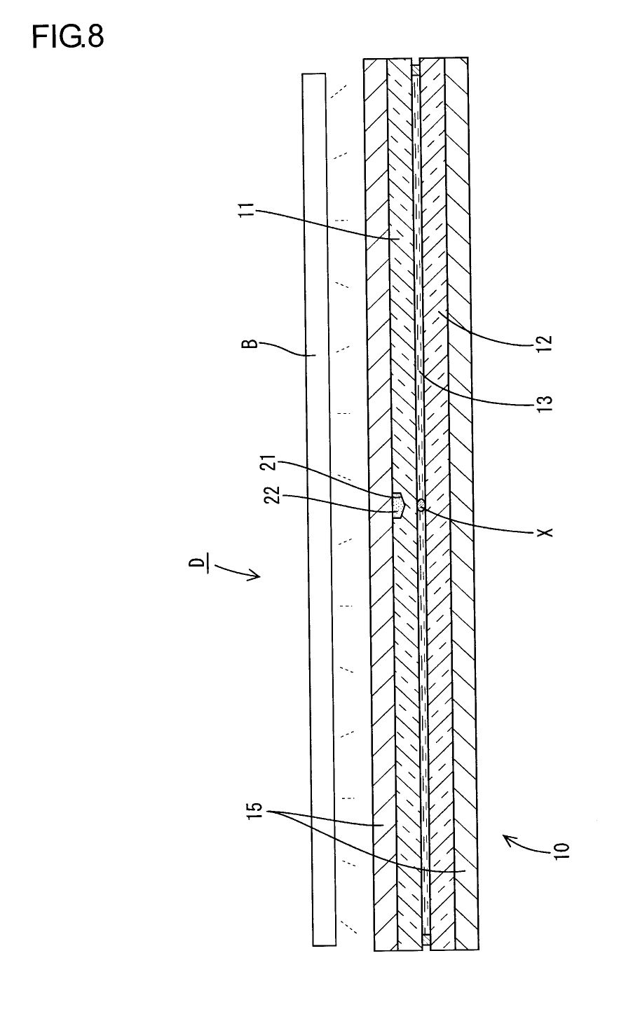

In this repair, as shown in FIG. 8, in the surface at the side opposite from the liquid crystal layer 13 of the glass substrate 11, a recessed part 21 is formed at the position corresponding to the foreign substance X (bright spot defect portion), and a light shielding layer 22 which shields light is formed in the recessed part 21. The light shielding layer 22 is composed of cashew lacquer which is a light shielding resin, and is charged into the recessed part 21 without a gap. The recessed part 21 is formed into a circular shape in plane view, and its bottom surface forms a conical shape which is the deepest at the center position. The recessed part 21 is set to have the diameter larger than the foreign substance X, and its size is changeable in the range of 300 to 400 μm in accordance with the size of the foreign substance X. Accordingly, the diameter of the recessed part 21 is set to be smaller than the length dimension of the long side of the pixel electrode 17 at the largest, and to be one time as large as or less than it. The recessed part 21 has the deepest portion set at the depth of about 350 μm, and its size is made about half the thickness dimension of the glass substrates 11 and 12.

The concrete repair process is constituted of a step of detecting and confirming the position and the size of the foreign substance X, a step of forming the recessed part 21 at the position corresponding to the foreign substance X in the front surface of the glass substrate 11, and a step of forming the light shielding layer 22 in the recessed part 21. Of them, the preceding two steps are successively performed by a recessed part forming device 30 which will be subsequently described. The step of forming the recessed part 21 includes a step of cutting the glass substrate 11 by the drill device 36, and a step of wiping out shavings which occur with cutting.

The recessed part forming device 30 is constituted of a stage 31 for mounting the liquid crystal panel 10 to be repaired, a pair of polarizing plates 32 for inspection which are disposed to sandwich the stage 31, a backlight 33 for inspection, and an XY drive part 34 which moves parallel with the stage 31. Of them, the XY drive part 34 is provided with a CCD camera 35 for confirming the position and the size of the foreign substance X, and a drill device 36 for cutting the surface of the glass substrate 11 to be adjacent to each other in predetermined positional relationship. As the drill bit 37 of the drill device 36, a plurality of drill bits 37 with different diameter sizes are prepared so as to be properly replaced in accordance with the size of the foreign substance X. The stage 31 is made of glass so as to be able to transmit the light of the backlight 33.

An operation of forming the recessed part 21 by the above described recessed part forming device 30 will be described. First, the liquid crystal panel 10 to be repaired is mounted at a predetermined position on the stage 31. At this time, the glass substrate 12 on the viewer side is set to be on the lower side and the glass substrate 11 at the side opposite from the viewer side is on the upper side. Then, the backlight 33 is lit to cause the liquid crystal display to perform black display. In the case of the liquid crystal panel of a normally white mode, each wiring of the glass substrate is connected to the circuit for inspection, and a signal is supplied to each wiring, whereby the liquid crystal display is caused to perform black display. While the XY drive part 34 is moved in this state, the display state is imaged by the CCD camera 35, and the imaged result is subjected to image processing, whereby the position and the size of the foreign substance X are determined. After the drill bit 37 which corresponds to the size of the foreign substance X that is grasped at this time is fitted to the drill device 36, the XY drive part 34 is moved to move the drill bit 37 of the drill device 36 to the position which conforms to the position of the foreign substance X.

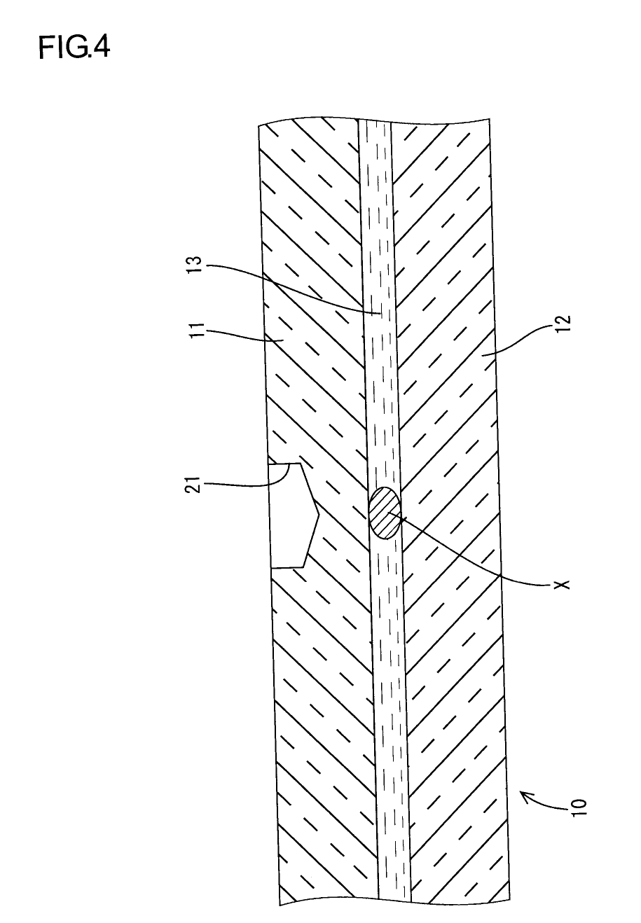

Then, by rotating the drill bit 37 at a high speed while lowering it, the portion corresponding to the foreign substance X in the surface of the glass substrate 11 at the side opposite from the viewer side is cut to form the recessed part 21 (see FIG. 4). The cut depth at this time (the depth dimension of the recessed part 21) is automatically controlled to be a numeral value which is set in advance. At the time of cutting, shavings of glass occur, and therefore, after the cutting operation is finished, the operation of wiping out the shavings is performed. This operation is performed in such a manner as to wipe the surface of the glass substrate 11 by a wiping member (not shown) impregnated with alcohol, and therefore, the shavings can be easily removed.

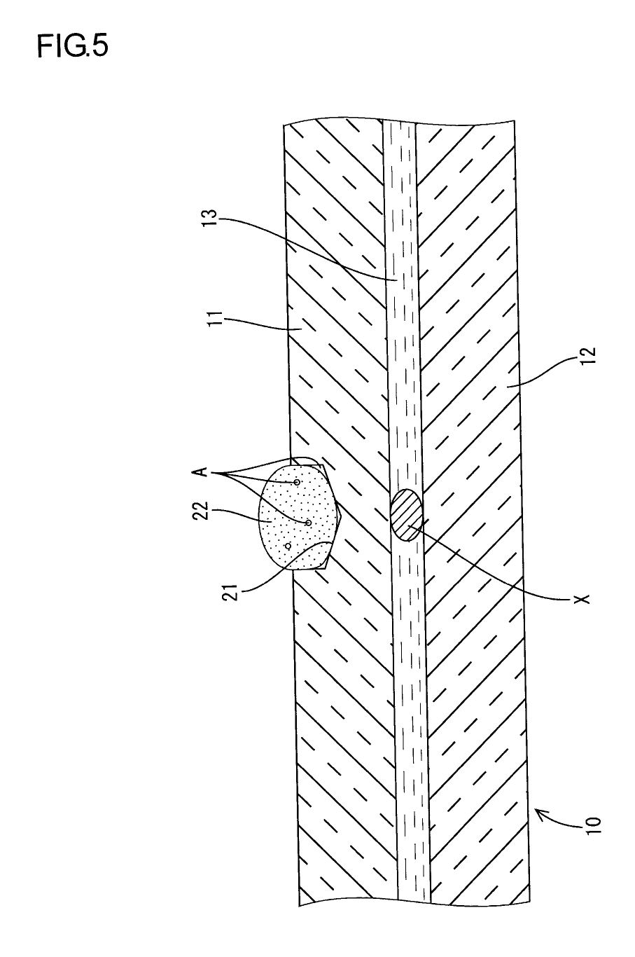

After the recessed part forming step is finished as described above, the step of forming the light shielding layer 22 in the recessed part 21 is started subsequently. The step of forming the light shielding layer 22 includes a step of charging cashew lacquer in the recessed part 21, a step of decompressing the periphery of the recessed part 21, a step of wiping out excess cashew lacquer, and a step of drying the cashew lacquer. First, from the state shown in FIG. 4, the cashew lacquer in a liquid state is charged into the recessed part 21 under atmospheric pressure to establish the state shown in FIG. 5. Since the cashew lacquer has proper viscosity, the charging operation can be easily performed. At this time, air bubbles A sometimes remain between the cashew lacquer and the peripheral surface of the recessed part 21 and in the cashew lacquer, and therefore, the operation of decompressing the periphery of the recessed part 21 is performed by a decompression device 40 which will be subsequently described to remove the air bubbles A.

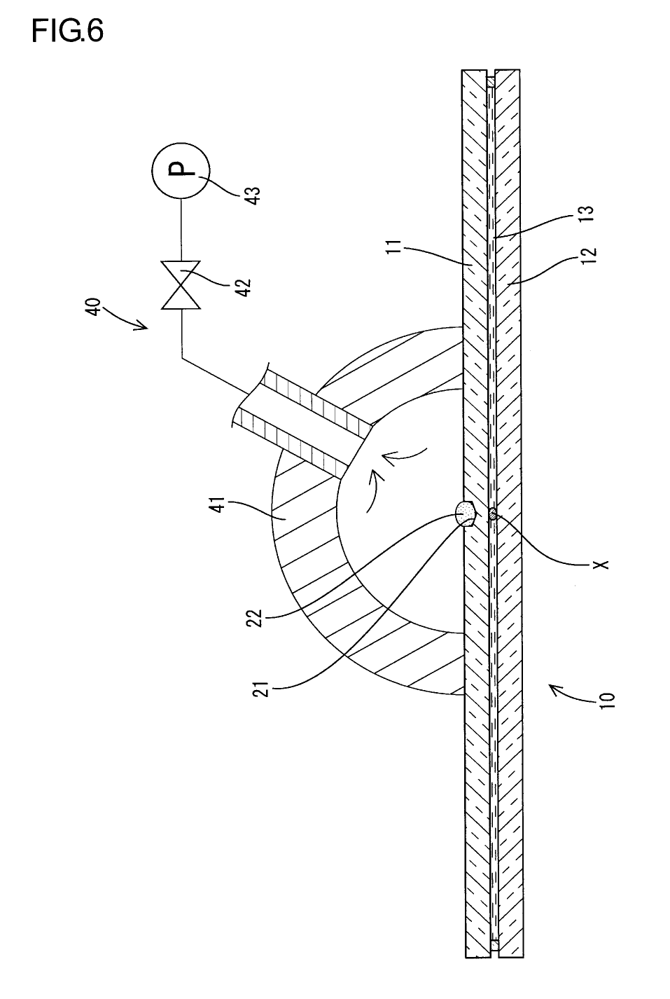

The decompression device 40 is constituted of a decompression cup 41 which forms a semispherical shape and capable of sucking the surface of the glass substrate 11, a valve 42 and a vacuum pump 43 which are connected to the decompression cup 41 as shown in FIG. 6. A sealant (not shown) is provided on the contact end surface with the glass substrate 11 in the decompression cup 41 so as to be able to be in close contact with the surface of the glass substrate 11 in an airtight state. When a decompressing operation is performed, the valve 42 is opened and the vacuum pump 43 is driven in the state in which the decompression cup 41 is applied to the recessed part formation region in the surface of the glass substrate 11. Then, the inside of the decompression cup 41, namely, the periphery of the cashew lacquer charged into the recessed part 21 is decompressed, and with this, the air bubbles A remaining between the cashew lacquer and the peripheral surface of the recessed part 21 and in the cashew lacquer are removed. Thereby, the light shielding effect of the light shielding layer 22 can be made uniform. After the inside of the decompression cup 41 is kept in the decompressed state for a predetermined time, the decompressed state is released and the decompression cup 41 is removed.

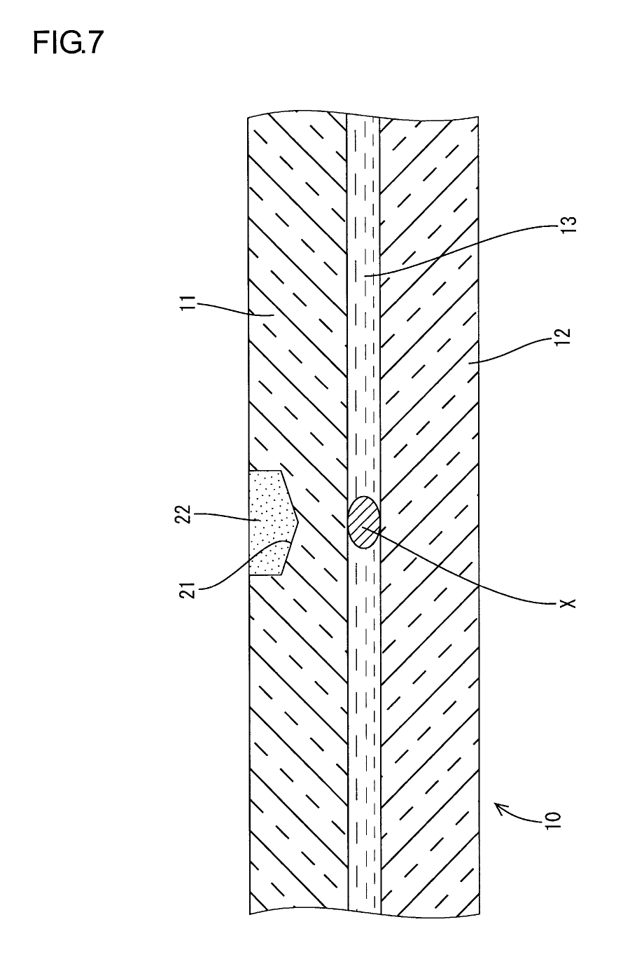

Thereafter, the operation of wiping out the portion of the cashew lacquer, which swells from the surface of the glass substrate 11, is performed. This operation is performed in such a manner as to wipe the surface of the glass substrate 11 by a wiping member (not shown) impregnated with alcohol, and therefore, excess cashew lacquer can be easily removed. Especially because the cashew lacquer is made by dissolving a resin into a solvent, it is easily wiped out. At this time, as shown in FIG. 7, the cashew lacquer is wiped out so that the cashew lacquer, namely, the surface of the light shielding layer 22 is flush with the surface of the glass substrate 11. Thereafter, the cashew lacquer is left at a room temperature for about 24 hours to dry the cashew lacquer. Though not shown in detail, the surface of the light shielding layer 22 is sometimes in the shape dented (recessed) from the surface of the glass substrate 11 as the result that the solvent of the cashew lacquer is vaporized as it is dried, but the light shielding layer 22 is formed in the state closely adhered to the entire range of the peripheral surface of the recessed part 21, and therefore, the light shielding range does not decrease.

After the step of forming the light shielding layer 22 in the recessed part 21 is finished as described above, an operation of bonding the polarizing plates 15 respectively onto the surfaces at the side opposite from the liquid crystal layer 13 in both the glass substrates 11 and 12 is performed next as shown in FIG. 8. At this time, the surface of the light shielding layer 22 is formed to be flush with or recessed from the surface of the glass substrate 11, namely, the surface of the light shielding layer 22 does not protrude (project) from the surface of the glass substrate 11, and therefore, protrusion does not occur to the bonded polarizing plate 15. If the surface of the light shielding layer protrudes from the surface of the glass substrate, the polarizing plate raised from the surface of the glass substrate by the protruded light shielding layer, a gap occurs between the glass substrate and the polarizing plate, and irregular reflection of light is likely to occur in that portion. Accordingly, the surface of the light shielding layer 22 is set so as not to protrude from the surface of the glass substrate 11, and thereby, occurrence of irregular reflection of light as described above can be prevented, thus making it possible to contribute to enhancement of display quality. The appearance is made excellent.

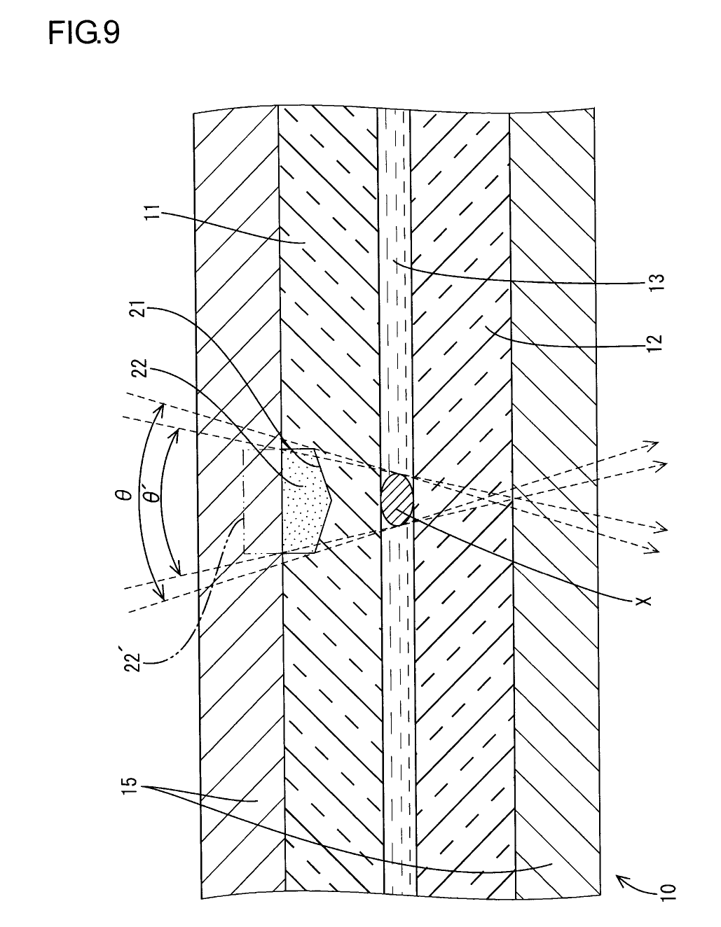

After a driver (not shown) and the backlight B are assembled to the liquid crystal panel 10 of which bright spot defect is corrected as above to form a liquid display device D, the liquid crystal panel 10 is lit and caused to perform black display, and it becomes as follows. Namely, the light, which is emitted from the backlight B and is incident on the foreign substance X, is shielded in an angle range θ by the light shielding layer 22 formed in the recessed part 21 as shown in FIG. 9. On the other hand, if a light shielding layer 22′ is provided to be stacked on the surface of the glass substrate 11 as in the conventional display (see the two-dot chain line in FIG. 9), the angle range in which light is shielded by the light shielding layer 22′ is θ′, and is smaller (narrower) than the above described θ. Namely, in this preferred embodiment, the light shielding layer 22 is formed in the recessed part 21 formed on the surface of the glass substrate 11, and therefore, as compared with the conventional one in which the shielding layer 22′ is stacked on the surface of the glass substrate 11, the distance between the light shielding layer 22 and the foreign substance X can be made short. Accordingly, the light shielding range by the light shielding layer 22 can be made larger than the conventional display as described above, and therefore, the amount of light capable of being incident on the foreign substance X can be decreased. Thereby, the foreign substance X becomes difficult to recognize as a bright spot, and thereby, display quality can be enhanced.

Since the recessed part 21 and the light shielding layer 22 are provided at the surface of the glass substrate 11 at the side opposite (backlight B side) from the viewer side of both the glass substrates 11 and 12, the recessed part 21 and the light shielding layer 22 (correction part) are hardly recognized visually by an external viewer, and excellent appearance is provided.

Furthermore, since the diameter of the recessed part 21 is set to be one time as large as or less than the dimension of the long side of the pixel electrode 17 which forms a rectangular shape, the entire display dot is not converted into a black spot by the light shielding layer 22, and degradation of the display quality can be suppressed.

Since the light shielding layer 22 is formed by a light shielding resin, equipment can be made simple as compared with the case where the light shielding layer is formed by metal plating. In addition, cashew lacquer is used as the light shielding resin, and therefore, as compared with the case where a two-part curing resin such as an epoxy resin is used, the light shielding resin is easily handled, and the liquid shielding layer 22 can be easily formed. The cashew lacquer is excellent in resistance to moist heat, resistance to heat, thermal shock and cryopreservation, and therefore, degradation of display quality is not caused.

In the decompressing step, only the required portion is decompressed by using the decompression cup 41 which is applied to the recessed part formation region of the surface of the glass substrate 11, and therefore, as compared with the case where, for example, the periphery of the entire liquid crystal panel is decompressed, simple equipment can be used.

### Preferred Embodiment 2

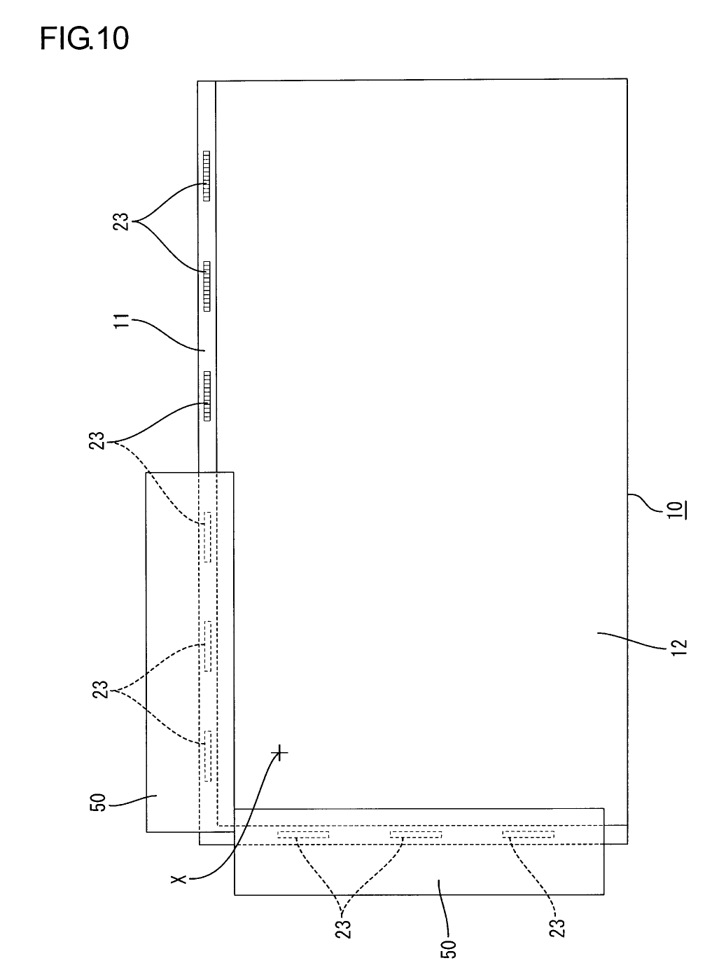

Preferred embodiment 2 of the present invention will be described based on FIG. 10. This preferred embodiment 2 protects the terminal part 23 of the glass substrate 12 when the recessed part 21 is formed in the glass substrate 11. In this preferred embodiment 2, redundant explanation of the same structure, operation and effect as those in the above described preferred embodiment 1 will be omitted.

Of the liquid crystal panel 10, the glass substrate 11 provided with the TFTs 16 (switching element) is formed to be larger than the glass substrate 12 provided with the color filter layers and the counter electrodes as shown in FIG. 10, and the terminal parts 23 which are connected to the respective wirings 18 and 19 led from the TFTs 16 are provided at its perimeter portion in the state in which they are exposed to the outside. A plurality of terminal parts 23 are provided side by side at each of the upper side end portion and the left side end portion of the perimeter portion of the glass substrate 11 (six at the upper side and three at the left side in FIG. 10), those arranged at the upper side end portion are connected to the source electrode (source wiring 18) of the TFTs 16, while those arranged at the left side end portion are connected to the gate electrode (gate wiring 19), respectively. An external circuit is connectable to each of the terminal parts 23.

When the foreign substance X is confirmed in the position in the vicinity of the terminal part 23 in the step of repairing the above described liquid crystal panel 10, an operation of putting a protection cover 50 which is made of a synthetic resin and formed into a sheet shape on the perimeter portion of the glass substrate 11 including the terminal parts 23 is performed prior to the step of cutting the glass substrate 11 by the drill device 36. More specifically, when, for example, the foreign substance X is confirmed in the vicinity of the upper left corner portion in FIG. 10 in the glass substrate 11, of the perimeter portion of the glass substrate 11, the region including the three terminal portions 23 for source at the left side is covered with the protection cover 50, and the region including all the terminal parts 23 for gate is covered with the protection cover 50. In this state, the operation of cutting the surface of the glass substrate 11 by the drill device 36 is performed. When the cutting operation is performed, shavings of glass and liquid lubricant supplied to the cut spot sometimes scatter in the periphery as the drill bit 37 of the drill device 36 rotates at a high speed. However, since the terminal parts 23 in the vicinity of the cut spot is protected by the protection cover 50 in advance as described above, scattered shavings of glass and lubricant can be prevented from adhering to the terminal parts 23.

### Modification Example

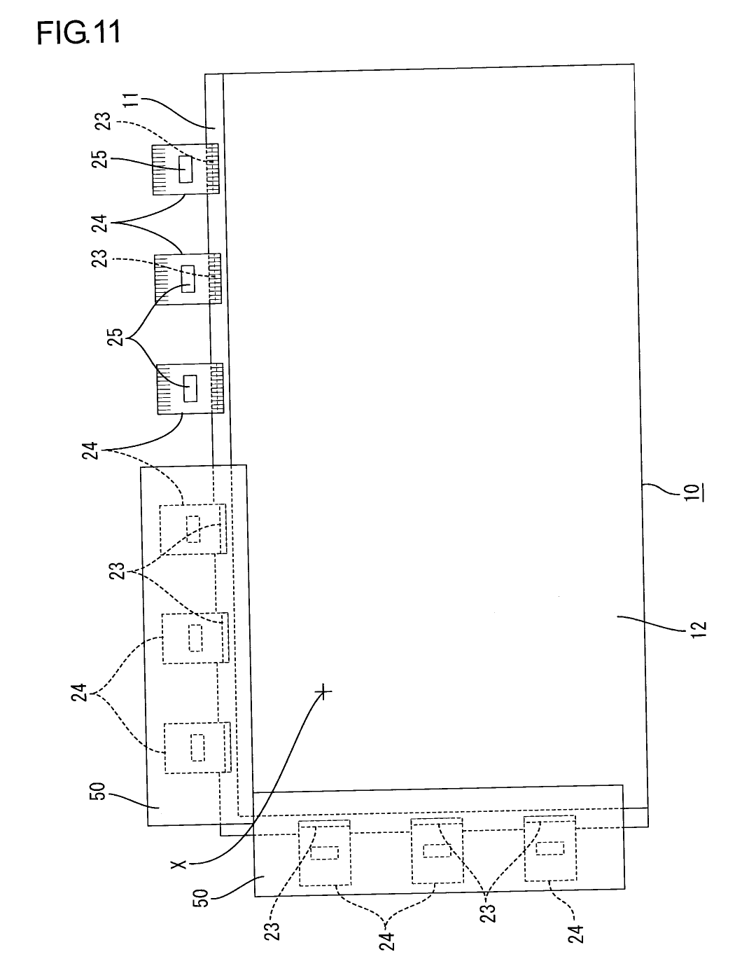

A modification example of the above described preferred embodiment 2 will be described based on FIG. 11. In this modification example, the case of repairing the liquid crystal panel 10 in which an electronic component 24 constituting an external circuit is mounted to each of the terminal parts 23 of the glass substrate 11 will be shown.

The electronic component 24 is for driving the TFTs 16, and has the construction in which a driver 25 such as an LSI chip is loaded on a film excellent in heat resistance and a connecting terminal to the terminal part 23 of the glass substrate 11 is provided at one end side of the film, and is called an SOF (SystemOnFilm) or the like. The electronic component 24 has its connecting terminal brought into pressure contact with each of the terminal parts 23 of the glass substrate 11 via an ACF (Anisotropic Conductive Film) not shown. The electronic component 24 is mounted to cover the terminal part 23 and is in the state exposed to the outside.

After the operation of mounting the electronic component 24 to the terminal part 23 is performed as described above, the same lighting inspection as already described is performed, and when the foreign substance X is detected at this time, the cutting operation of the glass substrate 11 is performed in the repair step. Prior to the cutting operation, the region including the electronic components 24 in the position in the vicinity of the foreign substance X in the glass substrate 11 is covered with the protection cover 50 as in the preferred embodiment 2. Thereby, shavings of glass and lubricant which scatter with cutting can be prevented from adhering to the electronic components 24. At the other end side of the film of the above described electronic component 24, the connecting terminal to the printed board not shown is provided, and when the above described cutting operation is performed with the printed board connected to the connecting terminal, the printed board as well as the electronic component 24 is covered with the protection cover 50.

### Other Preferred Embodiments

The present invention is not limited to the preferred embodiment described based on the above description and drawings, and for example, the following preferred embodiments are also included in the technical range of the present invention.

(1) A bright spot defect sometimes is caused from a flaw on the surface of a glass substrate, and in such a case, after the bright spot defect portion is removed by forming a recessed part in the bright spot defect portion (portion in which the flaw is formed in the glass substrate), a light shielding layer is formed in the recessed part, and thereby, light is shielded.

(2) A bright spot defect portion is sometimes caused by a switching element and a pixel electrode in which a failure occurs, and in such a case, the present invention is applicable.

(3) The present invention is also applicable to the liquid crystal panel using a switching element other than a TFT.

(4) The present invention is also applicable to a reflection type liquid crystal panel. In such a case, if a recessed part and a light shielding layer are provided in the glass substrate at the side opposite from the viewer side (light source side), a corrected part is hardly recognized visually by a viewer.

(5) The present invention is also applicable to the liquid crystal panel which performs black and white display other than the liquid crystal panels which perform color display.

(6) For the light shielding layer, a light shielding resin other than cashew lacquer (for example, an epoxy resin having a light shielding effect) may be used. Further, the light shielding layer may be formed by a material other than a light shielding resin (for example, metal having a light shielding effect).

(7) The light shielding layer may be in the shape in which its surface is protruded (projected) from the surface of the glass substrate, and such a light shielding layer is included in the present invention.

(8) The present invention is naturally applicable to a liquid crystal panel which is manufactured by dropping liquid crystal onto one of glass substrates in the step before both the glass substrates are bonded to each other.

(9) The present invention is also applicable to a normally white type liquid crystal panel.

(10) The diameter of the recessed part may be one time as large as or larger than the dimension of the long side of the pixel electrode, and such a recessed part is also included in the present invention. The diameter of the recessed part may be set to be smaller than the bright spot defect portion.

(11) On forming the recessed part, the surface of the glass substrate may be melted by, for example, a solvent, other than by cutting with the drill.

(12) In the above described preferred embodiment, a so-called direct type liquid crystal display in which the backlight is disposed directly under the liquid crystal panel is shown as an example, but other than this, the present invention is also applicable to, for example, a so-called edge light type liquid crystal display in which the backlight is located beside the liquid crystal panel.

(13) When the light shielding layer is formed from a material other than a light shielding resin (metal having, for example, a light shielding effect), the decompressing step can be omitted. Further, in the case of using a light shielding resin, the decompressing step may be omitted. Further, the step of wiping out the light shielding resin with the wiping member can be omitted.

(14) In the decompressing step, for example, the entire liquid crystal panel may be housed in the vacuum chamber of a vacuum degassing device, and the inside of the chamber may be decompressed.

(15) After the polarizing plates are bonded to both the glass substrates, the recessed part and the light shielding layer may be formed. In this case, the polarizing plate in which holes are made when the recessed part is formed is replaced with a new polarizing plate. In this case, the polarizing plates for inspection can be omitted from the inspecting device used for lighting inspection and the recessed part forming device.

What is claimed is:

1. A liquid crystal panel, comprising:
a first and second glass substrate capable of transmitting light emitted from an external light source, wherein the first glass substrate is positioned at a viewer side and the second glass substrate is positioned at a side opposite from the viewer side,
a liquid crystal layer positioned between the first and second glass substrate;
liquid crystal orientation control elements capable of controlling an orientation state of said liquid crystal layer by applying voltage between the first and second glass substrate;
polarizing layers positioned on the first and second glass substrate;
a recessed part formed at a position corresponding to a bright spot defect portion in a surface of the second glass substrate; and
a light shielding layer formed in said recessed part.

2. The liquid crystal panel according to claim 1, wherein
a surface of said light shielding layer is formed to be flush with a surface of said second glass substrate.

3. The liquid crystal panel according to claim 1, wherein
said light shielding layer is formed of a light shielding resin.

4. The liquid crystal panel according to claim 3, wherein said light shielding resin includes cashew lacquer

5. The liquid crystal panel according to claim 1, wherein a surface of said light shielding layer is recessed from a surface of said second glass substrate.

6. The liquid crystal panel according to claim 1,
wherein said liquid crystal orientation control element comprises a pixel electrode formed in one of said first and second glass substrate.

7. The liquid crystal panel according to claim 6, wherein said liquid crystal orientation control element includes a switching element for controlling voltage which is applied thereto.

8. The liquid crystal panel according to claim 7, wherein a diameter of said recessed part is one times as large as a dimension of a long side of said pixel electrode.

9. The liquid crystal panel according to claim 7, wherein a diameter of said recessed part is less than a dimension of a long side of said pixel electrode.

10. The liquid crystal panel according to claim 1, wherein said liquid crystal panel is of a black type in which a light transmittance becomes a minimum in a state in which voltage is not applied.

11. The liquid crystal panel according to claim 1, wherein said liquid crystal orientation control element includes a switching element for controlling voltage which is applied thereto, and said switching element is a TFT.

12. The liquid crystal panel according to claim 1, wherein said bright spot defect portion is at least one of a flaw formed on the surface of said glass substrate, a foreign substance adhering to the surface at a side of said liquid crystal layer in said glass substrate, and a foreign substance which mixes into said liquid crystal layer.

13. The liquid crystal panel according to claim 1, wherein said recessed part has a diameter larger than said bright spot defect portion.

14. The liquid crystal panel according to claim 1, wherein said recessed part is a conical shape which is the deepest at a center position.

15. The liquid crystal panel according to claim 1, wherein a backlight is disposed at a side opposite from a side of the viewer with respect to the first and second glass substrates, further wherein the backlight is used as said external light source.

16. A liquid crystal display, comprising:
a liquid crystal panel comprising a pair of glass substrates, a liquid crystal layer, liquid crystal orientation control elements, polarizing layers, a recessed part, and a light shielding layer, wherein said pair of glass substrates are capable of transmitting light emitted from an external light source, the pair of glass substrates being disposed at a side of a viewer and a side opposite from the viewer said liquid crystal layer is interposed between both of said glass substrates, said liquid crystal orientation control element is capable of controlling an orientation state of said liquid crystal layer by applying voltage between both of said pair of glass substrates said polarizing layers are positioned on said pair of glass substrates, said recessed part is formed in a position corresponding to a bright spot defect portion in the surface of at least one of the pair of glass substrates, the at least one of the pair of substrates is opposite the side of the viewer and said light shielding layer is formed in said recessed part, further wherein the external light source is positioned on the side opposite from the side of the viewer.

17. A method for manufacturing a liquid crystal panel, comprising:
a step of manufacturing a liquid crystal panel comprising a first and second glass substrate, a liquid crystal layer, liquid crystal orientation control elements, and polarizing layers, wherein said first and second glass substrates are capable of transmitting light emitted from an external light source, the first glass substrate being disposed at a side of a viewer and the second glass substrate being disposed at a side opposite from the viewer, said liquid crystal layer is interposed between both of said glass substrates, said liquid crystal orientation control element being capable of controlling an orientation state of said liquid crystal layer by applying voltage between both of said glass substrates, said polarizing layers positioned on surfaces of said first and second glass substrate;
a defect detecting step of detecting a position of a bright spot defect portion in a state in which the polarizing layers are positioned adjacent said first and second glass substrate;
a recessed part forming step of forming a recessed part in a position corresponding to said bright spot defect portion, said recessed part being formed in a surface of the second glass substrate; and
a light shielding layer forming step of forming a light shielding layer in the recessed part.

18. The method for manufacturing a liquid crystal panel according to claim 17, wherein said light shielding layer forming step includes a decompressing step of decompressing a periphery of a light shielding resin after charging the light shielding resin into said recessed part under atmospheric pressure.

19. The method for manufacturing a liquid crystal panel according to claim 18, wherein said light shielding layer forming step includes a step of wiping a surface of said light shielding resin by a wiping member impregnated with alcohol, after said decompressing step.

20. The method for manufacturing a liquid crystal panel according to claim 18, wherein in said decompressing step decompressed the periphery of the light shielding resin by applying a decompression cup to said recessed part and its peripheral portion.

21. The method for manufacturing a liquid crystal panel according to claim 19, wherein in said decompressing step decompressed the periphery of the light shielding resin by applying a decompression cup to said recessed part and its peripheral portion.

22. The method for manufacturing a liquid crystal panel according to claim 17, wherein said recessed part forming step includes a cutting step using a drill, and thereafter, a wiping step of wiping a surface of said glass substrate by a wiping member impregnated with alcohol.

23. The method for manufacturing a liquid crystal panel according to claim 18, wherein said recessed part forming step includes a cutting step by a drill, and thereafter, a wiping step of wiping a surface of said glass substrate by a wiping member impregnated with alcohol.

24. The method for manufacturing a liquid crystal panel according to claim 19, wherein
said recessed part forming step includes a cutting step by a drill, and thereafter, a wiping step of wiping a surface of said glass substrate by a wiping member impregnated with alcohol.

25. The method for manufacturing a liquid crystal panel according to claim 20, wherein
said recessed part forming step includes a cutting step by a drill, and thereafter, a wiping step of wiping a surface of said glass substrate by a wiping member impregnated with alcohol.

26. The method for manufacturing a liquid crystal panel according to claim 21, wherein
said recessed part forming step includes a cutting step by a drill, and thereafter, a wiping step of wiping a surface of said glass substrate by a wiping member impregnated with alcohol.

27. A method for manufacturing a liquid crystal panel which is a method for manufacturing a liquid crystal panel in which a terminal part connectable to an external circuit is provided at a perimeter portion of either one glass substrate of both said glass substrates, in claim 17, wherein
said recessed part forming step includes a cutting step by a drill, and prior to the cutting step, the perimeter part of said one glass substrate is covered with a protection member.

28. A method for manufacturing a liquid crystal panel which is a method for manufacturing a liquid crystal panel in which a terminal part connectable to an external circuit is provided at a perimeter portion of either one glass substrate of both said glass substrates, in claim 18, wherein
said recessed part forming step includes a cutting step by a drill, and prior to the cutting step, the perimeter part of said one glass substrate is covered with a protection member.

29. A method for manufacturing a liquid crystal panel which is a method for manufacturing a liquid crystal panel in which a terminal part connectable to an external circuit is provided at a perimeter portion of either one glass substrate of both said glass substrates, in claim 19, wherein
said recessed part forming step includes a cutting step by a drill, and prior to the cutting step, the perimeter part of said one glass substrate is covered with a protection member.

30. A method for manufacturing a liquid crystal panel which is a method for manufacturing a liquid crystal panel in which a terminal part connectable to an external circuit is provided at a perimeter portion of either one glass substrate of both said glass substrates, in claim 20, wherein
said recessed part forming step includes a cutting step by a drill, and prior to the cutting step, the perimeter part of said one glass substrate is covered with a protection member.

31. A method for manufacturing a liquid crystal panel which is a method for manufacturing a liquid crystal panel in which a terminal part connectable to an external circuit is provided at a perimeter portion of either one glass substrate of both said glass substrates, in claim 21, wherein
said recessed part forming step includes a cutting step by a drill, and prior to the cutting step, the perimeter part of said one glass substrate is covered with a protection member.

32. A method for manufacturing a liquid crystal panel which is a method for manufacturing a liquid crystal panel in which a terminal part connectable to an external circuit is provided at a perimeter portion of either one glass substrate of both said glass substrates, in claim 22, wherein
said recessed part forming step includes a cutting step by a drill, and prior to the cutting step, the perimeter part of said one glass substrate is covered with a protection member.

33. A method for manufacturing a liquid crystal panel which is a method for manufacturing a liquid crystal panel in which a terminal part connectable to an external circuit is provided at a perimeter portion of either one glass substrate of both said glass substrates, in claim 23, wherein
said recessed part forming step includes a cutting step by a drill, and prior to the cutting step, the perimeter part of said one glass substrate is covered with a protection member.

34. A method for manufacturing a liquid crystal panel which is a method for manufacturing a liquid crystal panel in which a terminal part connectable to an external circuit is provided at a perimeter portion of either one glass substrate of both said glass substrates, in claim 24, wherein
said recessed part forming step includes a cutting step by a drill, and prior to the cutting step, the perimeter part of said one glass substrate is covered with a protection member.

35. A method for manufacturing a liquid crystal panel which is a method for manufacturing a liquid crystal panel in which a terminal part connectable to an external circuit is provided at a perimeter portion of either one glass substrate of both said glass substrates, in claim 25, wherein
said recessed part forming step includes a cutting step by a drill, and prior to the cutting step, the perimeter part of said one glass substrate is covered with a protection member.

36. A method for manufacturing a liquid crystal panel which is a method for manufacturing a liquid crystal panel in which a terminal part connectable to an external circuit is provided at a perimeter portion of either one glass substrate of both said glass substrates, in claim 26, wherein
said recessed part forming step includes a cutting step by a drill, and prior to the cutting step, the perimeter part of said one glass substrate is covered with a protection member.

37. The method for manufacturing a liquid crystal panel according to claim 27,
wherein prior to the step of covering the perimeter portion of said one glass substrate with said protection member, an electronic component constituting said external circuit is mounted to said terminal part.

38. The method for manufacturing a liquid crystal panel according to claim 17,
wherein after going through said light shielding layer forming step, said polarizing layers are respectively stacked on the surfaces at the sides opposite from said liquid crystal layer in both of said glass substrates.

39. A manufacturing apparatus of a liquid crystal panel, comprising:
a stage capable of being mounted with a liquid crystal panel and transmitting light, said liquid crystal panel is capable of transmitting light emitted from an external light source, and includes a pair of glass substrates disposed at a side of a viewer and a side opposite from it to be opposed to each other, a liquid crystal layer interposed between both of said glass substrates, a liquid crystal orientation control element capable of controlling an orientation state of said liquid crystal layer by applying voltage between both of said glass substrates, and polarizing layers which are stacked on surfaces at sides opposite from said liquid crystal layer in both of said glass substrates;
a backlight capable of emitting light to said liquid crystal panel through said stage;
an XY drive part movable in parallel with said stage;
an imaging element which is provided at said XY drive part, and is capable of detecting a position and a size of a bright spot defect portion occurring to said liquid crystal panel by imaging said liquid crystal panel; and
a drill device which is provided at said XY drive part, and for forming a recessed part for forming a light shielding layer therein afterwards in a position corresponding to said bright spot defect portion in the surface at the side opposite from said liquid crystal layer in the glass substrate at the side opposite from the side of the viewer out of both of said glass substrates.

40. The manufacturing apparatus of a liquid crystal panel according to claim 39, further comprising:
a pair of polarizing layers disposed to sandwich said stage.
